(19) United States
(12) Patent Application Publication
(10) Pub. No.: US 2026/0249778 A1
(43) Pub. Date: Aug. 27, 2026

(54) SYSTEMS AND METHODS FOR ENHANCED VEHICLE VISUALIZATION

(71) Applicant: Ford Global Technologies, LLC, Dearborn, MI (US)

(72) Inventors: RAMI AL KHATIB, Dearborn, MI (US); Mahmoud Yousef Ghannam, Canton, MI (US); John Robert Van Wiemeersch, Novi, MI (US)

(73) Assignee: Ford Global Technologies, LLC, Dearborn, MI (US)

(21) Appl. No.: 19/061,351

(22) Filed: Feb. 24, 2025

(51) Int. Cl. B60Q 1/50; B60Q 5/00; G06V 20/58; G06V 40/20

(52) U.S. Cl. CPC B60Q 1/525; B60Q 5/006; G06V 20/58; G06V 40/20

(57) ABSTRACT

Systems and methods for enhancing visualization of a vehicle in an environment are provided. A vehicle may continually monitor people in its vicinity using internal and externals sensors to determine their trajectory and whether some are preoccupied currently, and if so, what is the level of their preoccupation. If the vehicle determines that the current trajectory of a person is likely to result in a physical interaction between the vehicle and the person and if the level of preoccupation exceeds a certain threshold, then the vehicle may output a direct alert toward the person. The vehicle may then continue to monitor the person's behavior to determine whether the alert resulted in a change in behavior of the persons such that the likelihood of the physical interaction is reduced or eliminated. If not, then the vehicle may modify the alert and keep outputting the modified alert until a change in behavior is detected.

### FIELD

The present disclosure relates to the field of automobiles. Specifically, embodiments of the present disclosure relate to methods and systems for establishing and/or enhancing a vehicle's presence and/or visualization for persons around the vehicle.

### BACKGROUND

Certain vehicles, such as electric vehicles or even some newer internal combustion engine-based vehicles, may produce less noise compared to traditional internal combustion engines vehicles. For example, electric vehicles may be quieter at low speeds, making it harder for people, especially those with visual impairments, to detect their approach. People may often rely on the sound of an approaching vehicle to judge its distance and speed. Silent electric vehicles reduce this natural auditory cue.

People using smartphones, headphones, or other devices may be preoccupied and therefore less likely to notice oncoming vehicles. The quietness of electric vehicles may add to this issue. Without auditory or visual signals, preoccupied people are less likely to look up or be aware of their surroundings.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an environment in which embodiments of the present disclosure can be implemented.

FIG. 2 illustrates a block diagram of a vehicle according to an embodiment of the present disclosure.

FIG. 3 illustrates an example scenario in which embodiments of the present disclosure may be implemented.

FIG. 4 illustrates a scenario 400 according to an embodiment of the present invention.

FIG. 5 illustrates a system according to an embodiment of the present invention.

FIG. 6 illustrates a flow diagram of a process according to an embodiment of the present disclosure.

FIG. 7 illustrates a flow diagram according to another embodiment of the present disclosure.

FIG. 8 illustrates a flow diagram according to yet another embodiment of the present disclosure.

FIG. 9 illustrates a flow diagram according to yet another embodiment of the present disclosure.

FIG. 10 illustrates a block diagram of a server according to an embodiment of the present disclosure.

### DETAILED DESCRIPTION

### Overview

The present disclosure describes systems and methods for increasing the awareness of a vehicle's presence in an environment. Specifically, embodiments of the present disclosure relate to systems and methods for outputting targeted alerts to persons in the vicinity of a vehicle to make those persons aware of the presence of the vehicle.

Embodiments of the present disclosure provide a method. The method includes determining the presence of a person in an environment around a vehicle and determining, based on a trajectory of the person, that the person is likely to be present within an interaction zone of the vehicle. The method further includes determining that the person is currently preoccupied, determining a level of preoccupation of the person, determining that the level of preoccupation exceeds a threshold, and outputting an alert in a direction toward the person.

In another instance, a method is provided that may include determining an interaction zone associated with a vehicle and determining that a person within the vicinity of the vehicle is likely to be present within the interaction zone in the near future. The method may further include determining that the person is currently preoccupied, determining environmental conditions in the vicinity of the vehicle, generating an alert based on the environmental conditions and the person being preoccupied, and outputting the alert.

In yet another instance, a vehicle is provided that may include one or more sensors, an interaction and prediction analysis unit including a controller and coupled to the one or more sensors, an alert generation and output unit coupled to the interaction and prediction analysis unit, and a memory device coupled to the controller and storing instructions. The controller may execute the instructions that cause the controller to determine, using the one or more sensors, presence of a person in an environment around the vehicle, determine, based on a trajectory of the person, that the person is likely to be present within an interaction zone of the vehicle, determine that the person is currently preoccupied, determine a level of preoccupation of the person, determine that the level of preoccupation exceeds a threshold, and cause the alert generation and output unit to output an alert in a direction toward the person.

These and other advantages of the present disclosure are provided in detail herein.

### Illustrative Embodiments

The disclosure will be described more fully hereinafter with reference to the accompanying drawings, in which example embodiments of the disclosure are shown and not intended to be limiting.

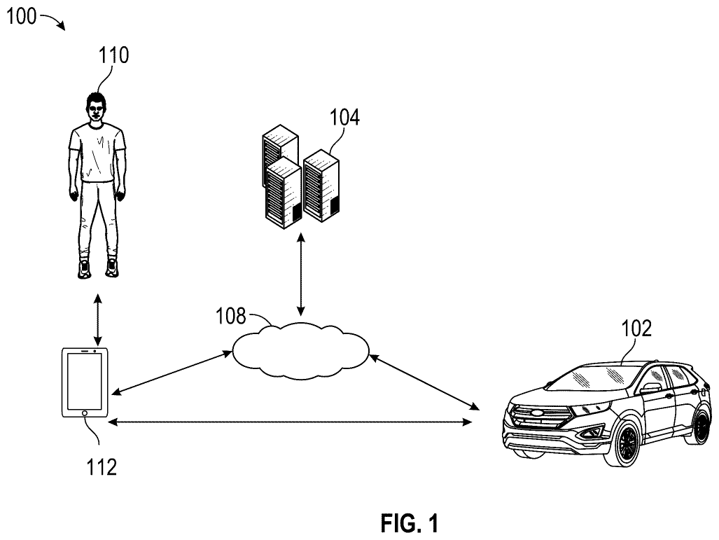

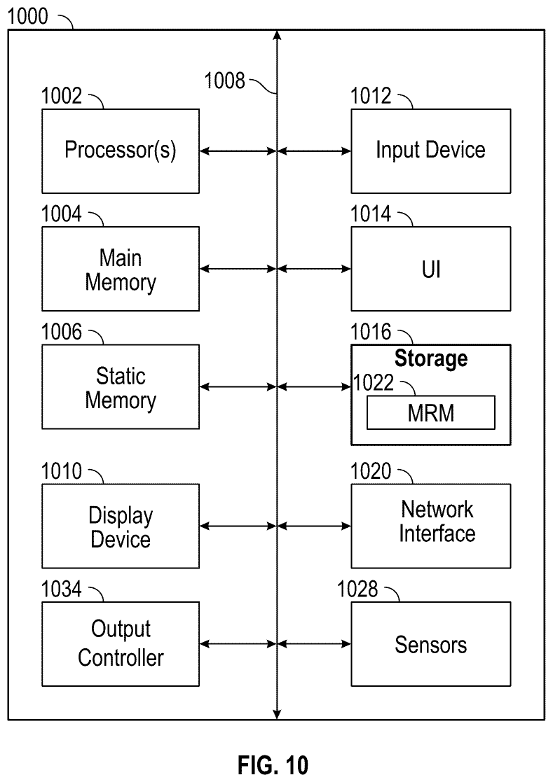

FIG. 1 illustrates an environment 100 in which the embodiments of the present disclosure may be implemented. The vehicle 102 can be any passenger or commercial vehicle such as a car, truck, tanker, bus, or the like. The vehicle 102 may be an autonomous vehicle or a vehicle that needs a person for driving. The environment 100 may also include a control server 104. The control server 104 may be part of a cloud-based computing infrastructure and may be associated with and/or include a Telematics Service Delivery Network (SDN) that provides digital data services to the vehicle 102. Details of the control server 104 are provided below with reference to FIG. 10.

The environment 100 may also include a user device 112. The user device 112 may be one of a mobile phone, a tablet, a personal computer, a smart key fob, or the like. The user device 112 may be associated with a user 110 of the vehicle 102. The user 110 may be a driver of the vehicle 102 or a passenger in the vehicle 102. The user device 112 may receive information from the vehicle 102 and/or the control server 104. The user device 112 may have a specialized application installed on it that can interface with the vehicle 102 to download and display various types of vehicle-generated information and other control data. In one embodiment, the vehicle 102 may communicate directly with the user device 112 to send and receive data without the need for the network 108 and/or the server 104.

The environment 100 may further include a network 108. The network 108 illustrates an example communication infrastructure in which the connected devices discussed in various embodiments of this disclosure may communicate. The network 108 may be and/or include the Internet, a private network, public network, or other configuration that operates using any one or more known communication protocols such as, for example, transmission control protocol/Internet protocol (TCP/IP), Bluetooth®, Bluetooth® Low Energy (BLE), Wi-Fi based on the Institute of Electrical and Electronics Engineers (IEEE) standard 802.11, ultra-wideband (UWB), and cellular technologies, such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

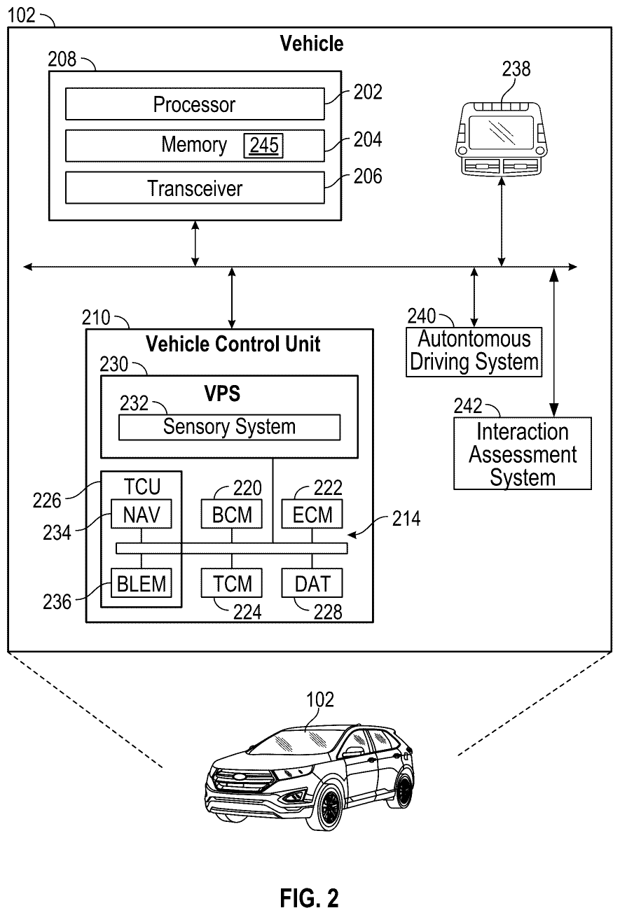

The vehicle 102 may include a plurality of units including, but not limited to, an automotive computer, a Vehicle Control Unit (VCU), and a detection unit. Details of the vehicle 102 are provided below in reference to FIG. 2.

FIG. 2 illustrates a block diagram of the vehicle 102 in which embodiments of the present disclosure can be implemented. The vehicle 102 may include a plurality of units including, but not limited to, an automotive computer 208, a Vehicle Control Unit (VCU) 210, and an infotainment unit 238. The VCU 210 may include a plurality of Electronic Control Units (ECUs) 214 that are in communication with the automotive computer 208.

In some embodiments, a user device, such as a mobile phone, a laptop computer, a smart fob, or the like, may be configured to connect with the automotive computer 208, which may communicate via one or more wireless connection(s), and/or may connect with the vehicle 102 directly by using near field communication (NFC) protocols, Bluetooth® protocols, Wi-Fi, Ultra-Wideband (UWB), and other possible data connection and sharing techniques.

The automotive computer 208 may be installed anywhere in the vehicle 102, in accordance with the disclosure. The automotive computer 208 may be or include an electronic vehicle controller, having one or more processor(s) 202, one or more memory devices 204, and one or more transceivers 206.

The processor(s) 202 may be disposed in communication with one or more memory devices that are in communication with the respective computing systems (e.g., the memory 204 and/or one or more external databases not shown in FIG. 2). The processor(s) 202 may utilize the memory 204 to store programs in code and/or to store data for performing operations in accordance with the disclosure. The memory 204 may be a non-transitory, computer-readable storage medium or memory storing a vehicle control program code. The memory 204 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.). In some embodiments, memory 204 may include a module 245 that can implement the various embodiments of the present disclosure. Module 245 may include instructions that can be executed by the processor 202 to realize the various embodiments of the present disclosure.

Automotive computer 208 may also include a transceiver 206. The transceiver 206 may be configured to receive information/inputs from one or more external devices or systems, e.g., a user device 208, an external server, and/or the like. Further, the transceiver 206 may transmit notifications, requests, signals, etc., to the external devices or systems. In addition, the transceiver 206 may be configured to receive information/inputs from vehicle components such as the vehicle sensory system 232, one or more ECUs 214, and/or the like. Further, the transceiver 206 may transmit signals (e.g., command signals) or notifications to the vehicle components such as the BCM 220, the infotainment system 238, and/or the like.

In some embodiments, the VCU 210 may share a power and/or communications bus with the automotive computer 208 and may be configured and/or programmed to coordinate the data between vehicle systems, connected servers, and/or the like. The VCU 210 may include or communicate with any combination of the ECUs 214, such as, for example, the BCM 220, an Engine Control Module (ECM) 222, a Transmission Control Module (TCM) 224, a Telematics Control Unit (TCU) 226, a Driver Assistance Technologies (DAT) controller 228, etc. The VCU 210 may further include and/or communicate with a Vehicle Perception System (VPS) 230, having connectivity with and/or control of one or more vehicle sensory system(s) 232. The vehicle sensory system 232 may include one or more vehicle sensors including, but not limited to, a Radio Detection and Ranging (RADAR or “radar”) sensor configured for detection and localization of objects inside and outside the vehicle 102 using radio waves, sitting area buckle sensors, sitting area sensors, a Light Detecting and Ranging (“LIDAR”) sensor, door sensors, proximity sensors, temperature sensors, wheel sensors, one or more ambient weather or temperature sensors, vehicle interior and exterior cameras, steering wheel sensors, etc. The sensors that are part of the vehicle sensory system 232 may be coupled to the vehicle 102 at one or more locations and in one or more configurations. For example, the various sensors of the vehicle sensory system 232 may be integrated into the various subsystems of the vehicle 102, such as doors, mirrors, roof, etc. or attached to the vehicle 102 using an appropriate mounting mechanism. In some embodiments, the various sensors of the vehicle sensory system 232 may be located at the front, back, sides, top, bottom, and underneath the vehicle 102. The location of a sensor may depend on its function. For example, a sensor that monitors the area underneath the vehicle may be connected to a bottom surface of the vehicle 102, while a sensor that can monitor an area to any side of the vehicle 102 may be mounted or integrated into the doors of the vehicle 102. Vehicle sensory system 232 may also include one or more road noise sensors, such as accelerometers that are coupled to various mechanical components and/or systems of the vehicle 102. One skilled in the art will realize that the sensors may be coupled with the vehicle in various ways and locations other than the ones mentioned above.

In some embodiments, the VCU 210 may control vehicle operational aspects and implement one or more instruction sets received from the server 104, the user device 112, or from one or more instruction sets stored in the memory 204.

The TCU 226 may be configured and/or programmed to provide vehicle connectivity to wireless computing systems onboard and offboard the vehicle 102 and may include a Navigation (NAV) receiver 234 for receiving and processing a GPS signal, a BLE® Module (BLEM) 236, a Wi-Fi transceiver, a UWB transceiver, and/or other wireless transceivers (not shown in FIG. 2) that may be configurable for wireless communication (including cellular communication) between the vehicle 102 and other systems (e.g., a vehicle key fob (not shown in FIG. 2), an external server, a user device, etc.), computers, and modules. The TCU 226 may be in communication with the ECUs 214 by way of a wired or wireless bus. In some aspects, the TCU 226 may be configured to determine a real-time vehicle geolocation, e.g., via the NAV receiver 234.

The ECUs 214 may control aspects of vehicle operation and communication using inputs from human drivers, inputs from the automotive computer 208, and/or via wireless signal inputs received via the wireless connection(s) from other connected devices, such as the server 206, among others.

The BCM 220 generally includes integration of sensors, vehicle performance indicators, and variable reactors associated with vehicle systems and may include processor-based power distribution circuitry that may control functions associated with the vehicle body such as lights, windows, security, camera(s), audio system(s), wipers, door locks and access control, various comfort controls, etc. The BCM 220 also may operate as a gateway for bus and network interfaces to interact with remote ECUs (not shown in FIG. 2).

The DAT controller 228 and/or the autonomous driving system 240 may provide Level-1 through Level-5 automated driving and driver assistance functionality that may include, for example, active parking assistance, vehicle backup assistance, and/or adaptive cruise control, among other features. The DAT controller 228 also may provide aspects of user and environmental inputs that are usable for user authentication.

In some embodiments, the automotive computer 208 may connect with an infotainment system 238 (or a vehicle Human-Machine Interface (HMI)). The infotainment system 238 may include a touchscreen interface portion and voice recognition features, biometric identification capabilities that may identify users based on facial recognition, voice recognition, fingerprint identification, or other biological identification means. In other aspects, the infotainment system 238 may be further configured to receive user instructions via the touchscreen interface portion and/or output or display notifications, navigation maps, etc. on the touchscreen interface portion. In some embodiments, the user device 112 may provide the HMI interface.

The computing system architecture of the automotive computer 208 and/or the VCU 210 may omit certain computing modules. It should be readily understood that the computing environment depicted in FIG. 2 is an example of a possible implementation according to the present disclosure, and thus, it should not be considered as limiting or exclusive.

The vehicle 102 may include an interaction assessment system 242. The interaction assessment system 242 may receive data from one or more sensors of the vehicle and/or one or more sensors in an external environment in which the vehicle is operating. Based on the data received, the interaction assessment system 242 may determine whether there are any persons in the vicinity of the vehicle that are likely to have a physical interaction with the vehicle 102. This determination may be done by predicting a trajectory of the one or more users based on the data received from the sensors. The interaction assessment system 242 may then generate an alert, such as a visual or audible alert, and send that alert to the one or more persons predicted to have a physical interaction with the vehicle 102. In an example, the alert may include light output, sound output, or a message being sent to the user device of the one or more persons that results in an alert being outputted by the user device. The interaction assessment system 242 may include a memory that is programmed with specialized instructions that can perform the above-detailed functions. In some embodiments, the interaction assessment system 242 may be integrated into the VCU 210.

In addition to the components noted above, the vehicle 102 may have numerous mechanical systems and subsystems. A chassis, frame, or unibody may form the backbone of the vehicle 102 and support the body and other components of the vehicle 102. The vehicle 102 may include an engine that converts fuel into mechanical power, propelling the vehicle forward. The engine includes various components such as the engine block, pistons, valves, and spark plugs. The vehicle 102 also may include a transmission system. The transmission system transfers the engine's power to the wheels. It includes the clutch, gearbox, driveshaft, and differentials, among other components. The transmission adjusts the power output to suit the vehicle's speed and load. The vehicle 102 also may include a suspension system. The suspension system absorbs shocks and maintains contact between the tires and the road, providing a smooth ride. It includes components such as springs, shock absorbers, and linkages. The vehicle 102 also includes a vehicle-stopping system that allows the driver to slow down or stop the vehicle 102. It includes components like pedals, master cylinders, lines, and pads or shoes. The vehicle 102 also includes a steering system that enables the driver to guide the car. The steering system includes components such as the steering wheel, steering column, rack and pinion, and tie rods. The vehicle 102 may further include an exhaust system that removes and filters the waste gases produced by the engine. It includes the exhaust manifold, catalytic converter, muffler, and tailpipe, among other components. The vehicle 102 also includes a cooling system that prevents the engine and/or battery from overheating. It includes components such as the radiator, water pump, thermostat, and coolant. The vehicle 102 may also include a cooling system that stores and supplies fuel to the engine. It includes the fuel tank, fuel pump, fuel filter, and fuel injectors. An electrical system of the vehicle 102 powers the car's electrical components. It may include the battery, alternator, starter motor, and wiring. The Heating, Ventilation, and Air Conditioning (HVAC) system controls the temperature inside the vehicle 102. It includes a heater core, blower motor, and air conditioning compressor. In some embodiments, the vehicle may be an electric vehicle (EV) or hybrid vehicle, and in either case, some of the aforementioned components would be replaced by an electric motor and a high-voltage battery. All the mechanical components working together ensure that the vehicle 102 operates optimally.

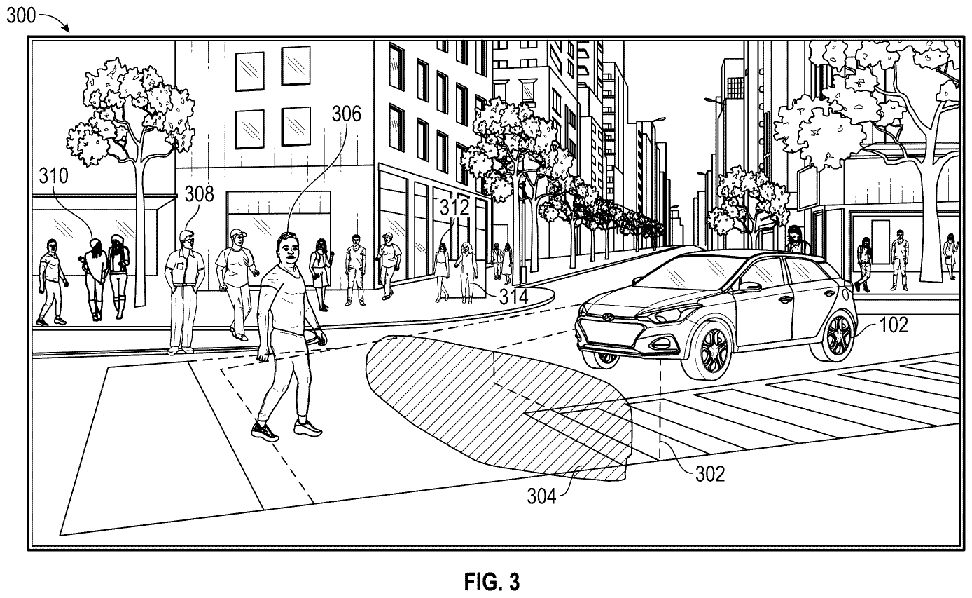

FIG. 3 illustrates an example scenario 300 in which embodiments of the present disclosure may be implemented. Scenario 300 depicts a typical busy road intersection in an urban area. The scenario 300 may include the vehicle 102 travelling along a road. As the vehicle 102 travels along the road, it may continuously monitor a first zone 302 in the immediate vicinity of the vehicle 102. The vehicle may use one or more external sensors to monitor the first zone 302. There may be a plurality of persons present in the vicinity of the vehicle. Each of these persons may be doing some activity and may be in various states of preoccupation. For example, the person 306 may be crossing the road while looking in a direction away from the vehicle 102. The person 308 may be talking on his mobile phone while he/she is attempting to cross the road. The person 310 may be standing on the sidewalk and may attempt to cross the road in the near future. The persons 312 and 314 may be engrossed in a conversation and may attempt to cross the road while being engaged in the conversation. Thus, there may be multiple persons in the vicinity of the vehicle in various states of preoccupation. At any given point in time, one or more of these persons may come into a second zone 304. The second zone 304 represents an area in the vicinity of the vehicle 102 in which there may be a high probability of the one or more persons coming in physical contact with the vehicle 102. In some embodiments, the second zone 304 is smaller than the first zone 302 and may be completely within the first zone 302. In other instances, the second zone 304 may at least partially overlap with the first zone 302. In the instance where the vehicle 102 is travelling at low speed and/or is generally silent in its operation, one or more of the persons present in the scenario 300 may not become aware of the presence of the vehicle 102. In some instances, any of the persons mentioned above may inadvertently attempt to cross the road while the crossing signal is red, indicating that users may not cross the road.

The vehicle 102 continually monitors the first zone 302 and also one or more persons in its vicinity. As part of monitoring the persons, the vehicle may determine a predicted trajectory of each of the persons, and based on the predicted trajectory, the vehicle 102 may determine whether any of the persons may occupy the second zone 304 at the same time the vehicle 102 is expected to be in the second zone 304. For example, consider the person 308 talking on his mobile phone and about to step on to the road to cross the road. In this situation, the vehicle 102 can determine based on its current speed and heading, an expected time when the vehicle 102 will be within the second zone 304. Similarly, the vehicle 102 may determine, based on the trajectory of the person 308, when the person 308 is likely to be within the second zone 304. The vehicle 102 may further determine that the person 308 is preoccupied (e.g., based on the image data of the person) since the person 308 is talking on his mobile phone. Based on the above, the vehicle may generate an alert and direct the alert toward the person 308 to make the person 308 aware of the presence of the vehicle 102. The alert may be in the form of an audio output, a light output, and/or a message to the person's mobile phone. In some embodiments, the vehicle may determine a level of preoccupation of the person 308 before outputting the alert toward the person 308. The vehicle may output an alert if the level of preoccupation is greater than a certain threshold. This will ensure that only the persons that are in the most need of the alert will get the alert without disturbing other people in the vicinity of the vehicle 102. In some embodiments, the alert may be sent to one or more users that may not be within the second zone 304. In other embodiments, the vehicle 102 may dynamically adjust the second zone 304 if there are objects on the road that may prevent the users from stepping into the second zone 304.

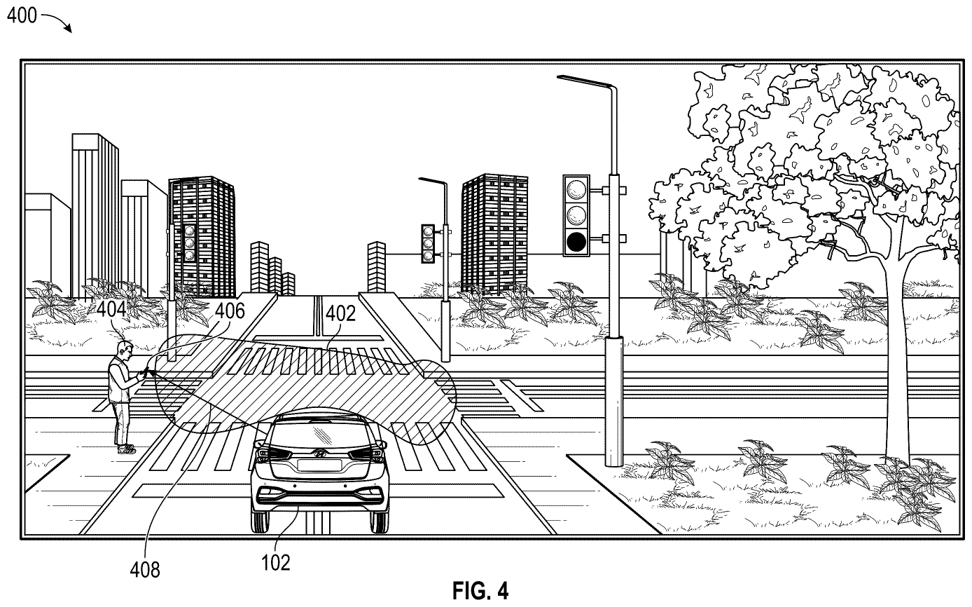

FIG. 4 illustrates a scenario 400 according to an embodiment of the present disclosure. In the scenario 400, a person 404 is stepping into the road crossing while the vehicle 102 has the right-of-way. The person 404 is busy interacting with his mobile device 406 and is not aware of the approaching vehicle 102. The vehicle 102 may detect presence of the person 404 using data from one more of the vehicle's sensors such as cameras, lidar, radar, ultrasonic sensors, etc. Thereafter, the interaction assessment system 242 of the vehicle 102 may use machine learning and computer vision techniques such as object detection algorithms (e.g., YOLO, SSD, or Faster R-CNN) and skeleton tracking algorithms to process the sensor data to detect the presence of the user 404. Thereafter, the vehicle 102 may track the motion of the person 404 over time to estimate their velocity and direction (e.g., using Kalman filter or optical flow techniques). Based on the determined velocity and direction, the interaction assessment system 242 may estimate that the person is likely to move into the zone 402. For example, the interaction assessment system 242 may use physics-based models, behavioral models, or machine learning models to predict the person's trajectory. The interaction assessment system 242 may then use the person's 404 trajectory and the vehicle 102 planned path and current speed to determine that there is a likelihood of a physical interaction between the vehicle 102 and the person 404 within the zone 402. Based on this determination, the interaction assessment system 242 may cause the vehicle 102 to output an alert 408 to the person 404.

The alert 408 may be in the form of directed audio. For instance, one or more speakers of the vehicle 102 may use beamforming to output audio in the direction of the user. In this example, multiple speakers of the vehicle may emit sound waves simultaneously. The timing (phase) and amplitude of the sound waves from each speaker are adjusted so that the waves combine constructively in the desired direction and destructively elsewhere. Thus, the vehicle 102 can focus the audio in the direction of the person 404. The person 404 may then hear the sound and become aware of the presence of the vehicle 102. In another example, the alert 408 may be in the form of light output. Since the likely location of the person 404 is known by the vehicle 102 based on the trajectory determination, the vehicle can activate one more light emitting devices to direct light in the direction of the user. This can be achieved by using directional light control techniques. Based on the trajectory of the person 404, the interaction assessment system 242 may cause the vehicle to operate one or more lights of the vehicle to direct one or more beams of light toward the persons 404. For example, the vehicle 102 may include headlights or other lights that are mounted to gimbals or rotary actuators. The vehicle 102 may operate one or more of the motorized mounts and/or rotary actuators to direct light output toward the person 404. In some instances, the vehicle may adjust the alert based on environmental conditions such as ambient light, noise levels, etc.

In yet another instance, the alert 408 may be in the form of a Bluetooth Low Energy (BLE) advertisement. BLE advertisements are short, broadcast packets that may include device information (e.g., name, UUID, address), optional data for pairing or interaction, and specific flags or payloads for applications. The vehicle 102 may direct the BLE advertisement message to the person's mobile device 406 using techniques such as device filtering and/or resolvable private address (RPA). The person's mobile device 406 may receive the BLE packet and display a message alerting the user 404 of the presence of the vehicle 102.

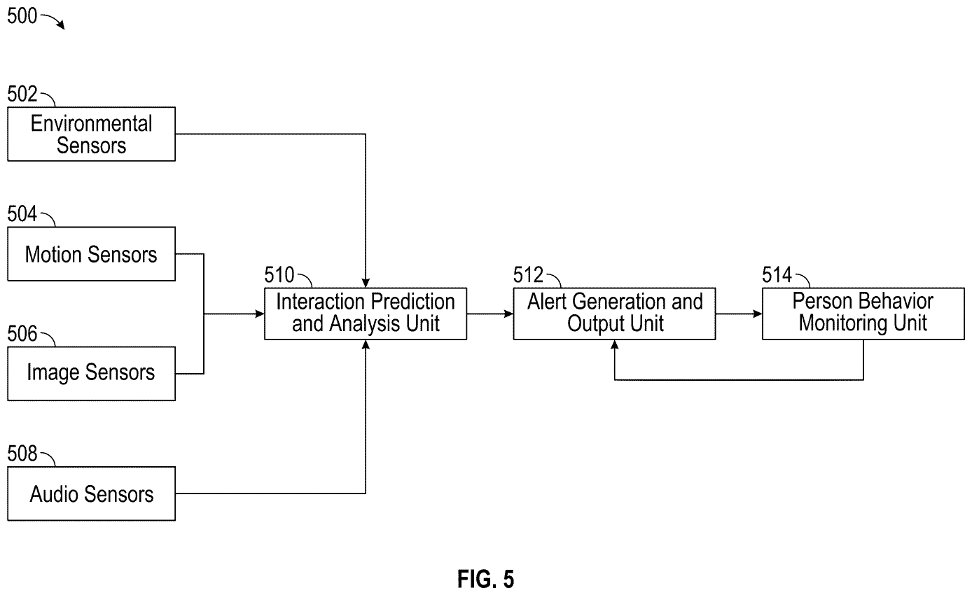

FIG. 5 illustrates a system 500 according to an embodiment of the present disclosure. In an embodiment, the system 500 can be solely implemented in the vehicle 102 of FIG. 2. In other embodiments, the system 500 may be implemented partially in the vehicle 102 and partially in the server 104 of FIG. 1. The system 500 may be used to detect presence of a person, determine a trajectory of the person, determine a level of awareness/preoccupation of the person, determine likelihood of contact between the person and the vehicle, generate an alert for the person, monitor the person's behavior after outputting the alert, and adjust the alert based on the person's behavior and/or the environmental conditions. The system 500 may include a plurality of sensors of the vehicle as well as sensors outside the vehicle. The sensors may include environmental sensors 502. The environmental sensors 502 may include air quality sensors (e.g., particulate matter (PM) sensors (e.g., PM2.5, PM10), carbon dioxide (CO2) sensors, etc.), weather and atmospheric sensors (e.g., temperature sensors, humidity sensors, barometric pressure sensors, wind speed sensors, wind direction sensors, rainfall sensors (pluviometers), snow depth sensors, solar radiation sensors (pyranometers), UV index sensors, lightning detectors, cloud cover sensors, etc.), light and radiation sensors (e.g., light intensity sensors (lux meters), ultraviolet (UV) sensors, infrared (IR) sensors, visible spectrum sensors, etc.), noise and vibration sensors (e.g., sound level meters, microphones for noise monitoring, vibration sensors (accelerometers, geophones), seismometers (earthquake monitoring), etc.), and/or motion and position sensors. The system 500 may also include motion sensors 504. The motion sensors 500 may include passive infrared (PIR) sensors, ultrasonic sensors, microware sensors, radar, proximity sensors, vibration sensors, inertial sensors, optical sensors, Micro-Electro-Mechanical Systems (MEMS) sensors, or the like.

The system 500 may also include image sensors 506. The image sensors 506 may include Charge-Coupled Device (CCD) sensors, Complementary Metal-Oxide-Semiconductor (CMOS) sensors, Time-of-Flight (ToF) sensors, IR sensors, UV sensors, visible spectrum sensors, lidar, and the like. The system 500 may further include audio sensors 508. The audio sensors 508 may include microphones, MEMA microphones, fiber optic microphones, sound level meters, directional microphones, omnidirectional microphones, ultrasonic sensors, acoustic emission sensors, bioacoustics sensors, etc. The sensor 502-508 may also include sensors located outside the vehicle in the environment around the vehicle. For example, one or more infrastructure sensors present in the environment, such as cameras and/or motion sensors, traffic light sensors, etc.

The system 500 may include an interaction prediction and analysis unit 510. The interaction and prediction analysis unit 510 may receive data from all the different sensors 502-508. The interaction and prediction analysis unit 510 may use vehicle-to-infrastructure (V2X) communication protocols to receive data from sensors located in the external environment of the vehicle. The interaction prediction and analysis unit 510 may use the various sensor data to determine the presence of one or more persons within the vicinity of the vehicle, determine a trajectory of the one or more persons, and determine a level of awareness/preoccupation of the one or more persons. For example, the sensor data may be used to monitor a person's behavior over time. If it is determined that the person has been looking at his/her mobile device for a certain period of time without looking elsewhere, the system 500 may conclude that the person is at a high level of preoccupation. A threshold for a level of preoccupation can be determined based on analysis of historical data from a plurality of vehicles in a plurality of conditions. The interaction prediction and analysis unit 510 may further determine a likelihood of interaction between the person and the vehicle based on the vehicle's current speed and heading and the person's trajectory. If the interaction prediction and analysis unit 510 determines that physical contact between the user and the vehicle is likely to occur in the near future, the interaction prediction and analysis unit 510 may send a message to the alert generation and output unit 512 indicating the same.

The alert generation and output unit 512 may then determine the current environmental conditions and/or characteristics associated with the user to determine a type of alert to be output. For example, if it is currently nighttime, the alert generation and output unit 512 may determine that a light output is optimal to alert the user. If the environmental sensors indicate that the environment is noisy, it may not be optimal to output an audio alert or an audio alert with high amplitude may need to be output so that the person can hear the sound over the noise. In another instance, if the environment is too bright, outputting light may not be as effective as outputting sound. In other words, the alert generation and output system monitors the environmental conditions external to the vehicle and dynamically adjusts the type of alert outputted by the vehicle. This ensures that the optimal type of alert is output such that the intended person can receive the alert and act accordingly. In some instances, system 500 also includes a person behavior monitoring unit 514. The person behavior monitoring unit 514 may track the person who is the subject of the alert output by the alert generation and output unit 512. The person behavior monitoring unit 514 detects the actions of the person after the alert has been output to determine if there is a change in the person's behavior. In some instances, the person receiving the alert may adjust his/her trajectory such that they move away from the vehicle path eliminating the likelihood of contact. In other instances, the person may continue on the present trajectory even after the alert is output. This may be an indication that the person did not receive the alert. The person behavior monitoring unit 514 provides this feedback to the alert generation and output unit 512. The alert generation and output unit 512 may modify the alert and output the modified alert. This process of feedback and dynamic adjustment of the alert may be continued until the person modifies their behavior. The modified alert may include a different type of alert (e.g., light vs. sound), the alert being output at a different frequency and/or amplitude, outputting the alert at a different rate, etc.

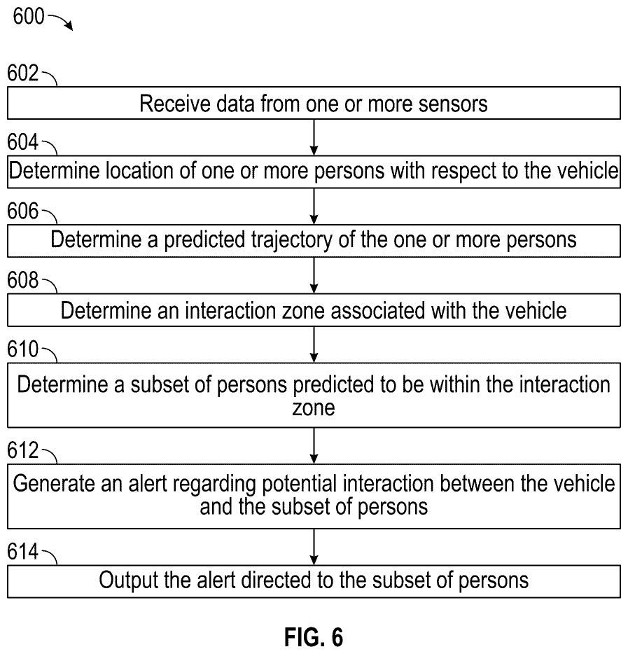

FIG. 6 is a flow diagram of a process 600 according to an embodiment of the present disclosure. The process 600 may be performed solely by the system 500 of the vehicle 102 or the vehicle 102 in conjunction with the server 104. At step 602, the vehicle may receive data from one or more sensors. As explained above, the one or more sensors may include the sensors of the vehicle as well as sensors that are external to the vehicle and part of the environment around the vehicle. At step 604, the data from the one or more sensors is used to detect presence of one or more persons in the vicinity of the vehicle. In addition, the location of each of the one or more persons with respect to the vehicle may also be determined. Thereafter, at step 606, the trajectory of the one or more persons is determined using any of the techniques described above. Based on the predicted trajectory of the one or more persons and the vehicle's trajectory, the vehicle may further determine a zone or area within which an interaction between the one or more persons and the vehicle is likely to occur, at step 608. Thereafter, at step 610, the vehicle may determine a subset of the one or more persons is likely to be present in the zone at the same time the vehicle is likely to be in the zone. This subset of persons are the ones most likely to have a physical interaction with the vehicle. At step 612, the vehicle may generate an alert indicative of the presence of the vehicle. As explained above, the alert may be in the form of a light output, an audio output, or a message receivable by a device associated with each person of the subset of people. At step 614, the vehicle may output the alert in a direction toward the subset of persons using any of the techniques described above. The subset of persons may then receive the alert and change their trajectory to move away from the path of the vehicle thereby preventing the potential physical interaction with the vehicle.

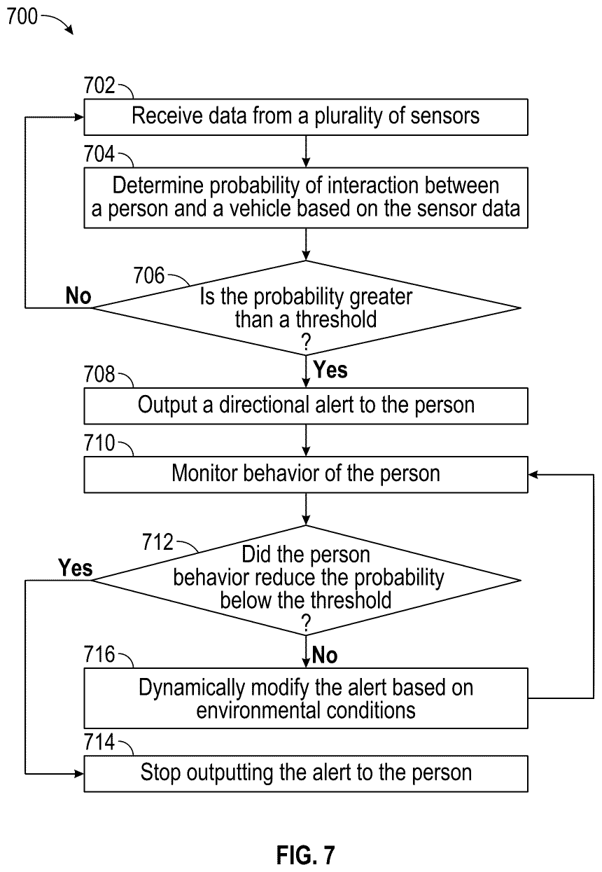

FIG. 7 is a flow diagram of a process 700 according to another embodiment of the present disclosure. Process 700 may be performed solely by the system 500 of the vehicle 102 or the vehicle 102 in conjunction with the server 104. At step 702, the vehicle may receive data from a plurality of sensors. The plurality of sensors may include the sensors of the vehicle as well as sensors that are external to the vehicle and part of the environment around the vehicle. The data from the sensors may be used by the vehicle to determine the presence of a plurality of people in the vicinity of the vehicle. The data from the sensors may be further used to determine predicted trajectory of each of the plurality of people in the vicinity of the vehicle. Thereafter, based on the trajectory of each of the plurality of people, and the trajectory of the vehicle and its speed, the vehicle may determine a person from among the plurality of people that is likely to have a physical interaction with the vehicle, at step 704. In addition, the vehicle may also determine whether the person is currently preoccupied (e.g., talking on a mobile phone). Thereafter, at step 706, the vehicle may determine whether the probability/likelihood of the person having a physical interaction with the vehicle is greater than a certain threshold. If the probability is less than the threshold, the process 700 may return to step 702, and the vehicle may continue to monitor the person using real-time data from the sensors.

If at step 706, it is determined that the probability of the person having a physical interaction with the vehicle is greater than a threshold, the vehicle may output a directional alert toward the person at step 708. The directional alert is output to make the person aware of the presence of the vehicle. In some embodiments, the vehicle may also output the directional alert if the person is determined to be currently preoccupied. At step 710, the vehicle may monitor the behavior of the person after outputting the alert to determine whether the person has received the alert. The real-time data from the one or more sensors may be used to continually monitor the behavior of the person. At step 712, the vehicle may determine whether the person has changed their behavior such that the probability of physical interaction with the vehicle is reduced below the threshold. For instance, if the person is busy talking on their mobile device while they are walking and then stops walking and looks up/around after the alert is outputted, then that may be an indication that the person has received the alert. There may be other behavior changes that may indicate that the person has received the alert. If it is determined that the person has changed their behavior to reduce the probability of physical contact with the vehicle, the vehicle may stop outputting the alert at step 714.

If at step 714 it is determined that the person has not changed their behavior, the vehicle may conclude that the person has not received the alert. In this instance, the vehicle may modify the alert based on the current environmental conditions and output the modified alert. The alert may be modified using any of the techniques described above. Once the modified alert is output, the vehicle may again monitor the person's behavior and the process 700 may return to step 710. The process may perform steps 710, 712, and 716 iteratively until the person modifies their behavior to reduce or eliminate the probability of physical interaction with the vehicle.

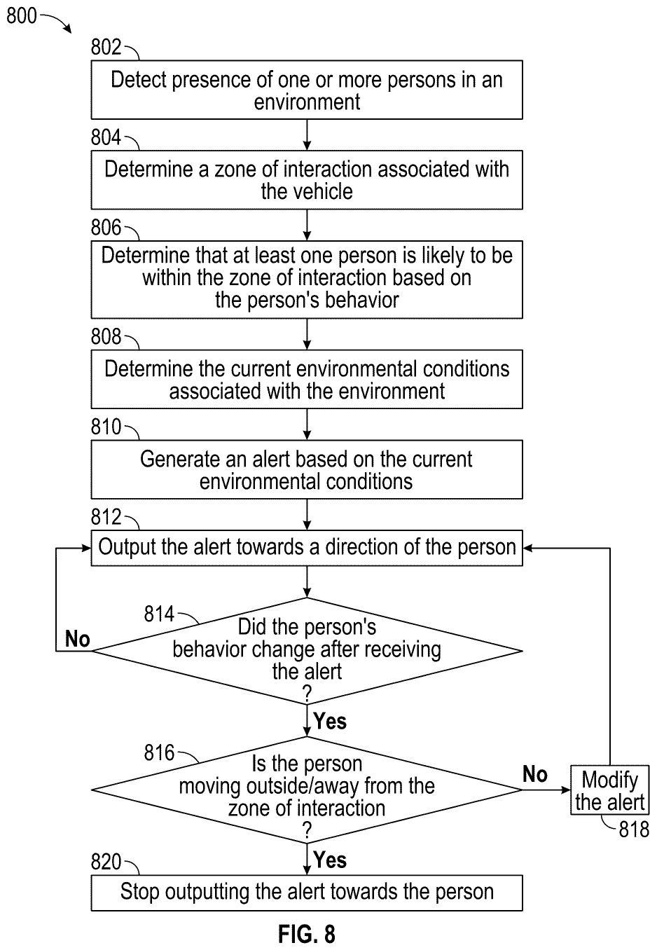

FIG. 8 is a flow diagram for a process 800 according to yet another embodiment of the present disclosure. Process 700 may be performed solely by the system 500 of the vehicle 102 or the vehicle 102 in conjunction with the server 104. At step 802, the system may detect the presence of one or more persons in an external environment of the vehicle and in the vicinity of the vehicle. The system may use sensor data from sensors internal to the vehicle and/or external to the vehicle in order to detect the presence of the persons. The system may also determine, at step 804, a zone of interaction associated with the vehicle. In an embodiment, the zone of interaction may be similar to zone 304 described above in relation to FIG. 3. If the vehicle is in motion, the zone of interaction may continually change, and the system may determine this zone in real-time and continually update the zone of interaction based on the vehicle speed and direction. At step 806, the vehicle may determine that at least one person, from the detected persons, is likely to be present in the zone of interaction in the near future. The system may make this determination based on a current trajectory of the person and the trajectory of the vehicle.

At step 808, the system may determine the current environmental conditions in the vicinity of the vehicle. As noted above, the environmental conditions may include ambient light, ambient noise, level of preoccupation of the person, etc. Based on the current environmental conditions, the system may generate an appropriate alert at step 810. For example, if it is very bright outside, the system may prefer to generate an audio alert instead of a visual alert, since it is more likely that the person will hear the visual alert in the given conditions. In other words, the system will generate an alert that has the highest chance of being received/perceived by the person given the current environmental conditions. At step 812, the system may then output the alert toward the direction of the user. Any of the above-described techniques for outputting direction alerts (e.g., beamforming, directed light, BLE advertisement message, etc.) may be used to direct the alert in the direction of the person. This also ensures that other persons who may be present in the vicinity of the vehicle, but not expected to be present in the interaction zone of the vehicle, are not unduly bothered by the alert. This type of directed alert ensures that only the person most concerned receives the message.

At step 814, the system may monitor the person's behavior after outputting the alert to determine whether there is any change in the person's behavior. For example, after receiving the alert, the person may change their trajectory such that they are unlikely to be present within the interaction zone of the vehicle. If at step 814 it is determined that the person has not changed their behavior, the system may continue to output the alert. For instance, the person may continue on their previous trajectory indicating that the person has not received the alert. In an embodiment, steps 812 and 814 may be repeated several times until the person changes their behavior. If at step 814 it is determined that the person has changed their behavior, the system may then determine whether the change in behavior is likely to result in the person moving away or outside the zone of interaction, at step 816. For instance, the person may change their behavior as determined at step 814, but the change in behavior may not be due to the alert but for some other reason. Thus, while the person may change their behavior, they may still continue on their previous trajectory indicating that the change in behavior is not likely due to the alert. In this instance where it is determined that the change in behavior of the user is unlikely to lessen the chance of physical interaction with the vehicle, the system may modify the alert at step 818 and output the modified alert. For instance, the system may change the type of alert (sound vs. light vs. BLE message), change the intensity of the alert (e.g., amplitude of the sound or brightness of the light), or change the frequency/rate of the alert, etc. In an embodiment, steps 812, 814, 816, and 818 may be repeated until it is determined that the person's change in behavior is due to the alert, and the change will likely result in the person not being within the zone of interaction. Once it is determined that the person is unlikely to be present within the zone of interaction, the system may stop outputting the alert at step 820.

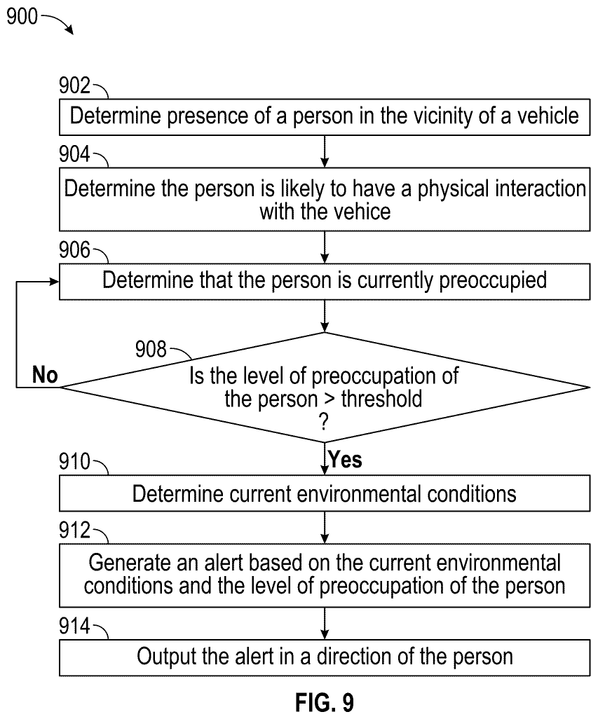

FIG. 9 is a flow diagram of a process 900 according to another embodiment of the present disclosure. Process 900 may be performed solely by the system 500 of the vehicle 102 or the vehicle 102 in conjunction with the server 104. At step 902, the system may detect the presence of a person in the vicinity of the vehicle using any of the techniques described above. At step 904, the system may determine whether the person is likely to have a physical interaction with the vehicle in the near future (e.g., based on the trajectory of the person and the trajectory of the vehicle). At step 906, the system may determine that the person is currently preoccupied. This determination may be made using image data captured by the vehicle. For example, the person may be interacting with their mobile device, engrossed in a conversation with another person, wearing headphones, etc. In other instances, the person may be carrying a walking stick that may indicate a physical disability that may affect the person's ability to perceive their surroundings. For example, a person carrying a white walking stick may indicate that the person is visually impaired, a person carrying a white walking stick with a red band or bottom may indicate that the person is both visually and hearing impaired, etc.

At step 908, the system may determine a level of preoccupation associated with the user and determine whether that level of preoccupation is greater or less than a certain threshold. For example, it may be inconvenient to output an alert to people if someone is only temporarily preoccupied but otherwise aware of their surroundings (e.g., someone who momentarily looks at their mobile device but otherwise is aware of their surroundings). A threshold may be set for the level of preoccupation. For example, the threshold may be in terms of time duration. For instance, if a person is deemed to be preoccupied for more than five seconds, then the system may determine that the person's level of preoccupation exceeds the threshold. In other instances, the threshold may be in terms of physical characteristics of the person. For example, if the person is carrying one of the aforementioned walking sticks, the system may determine that the level of preoccupation of that person is greater than the threshold. One skilled in the art will realize that various other forms of thresholds can be implemented. In another example, historical data about signs or preoccupation may be used to determine the proper threshold. For example, a machine learning model may be generated using historical data about behavioral indicators (e.g., reaction time, eye movement, body language, speech patterns, etc.), contextual cues (e.g., task performance, environment scanning, engagement tests, etc.), environmental context (e.g., ambient noise, ambient light, etc.), facial recognition, attention-tracking software data, and/or physiological indicators (e.g., heart rate variability, eye tracking, brainwave activity, galvanic skin response, etc.) associated with people. The model can then output a classification label or a continuous score representing the level of preoccupation. For example, the levels of preoccupation may be defined as focused, moderately preoccupied, highly preoccupied. The machine learning model used may be a supervised model, an unsupervised model, a deep learning model, or the like. The model may be deployed in the vehicle to reduce the latency of the determination.

If at step 908 it is determined that the level of preoccupation does not exceed the threshold, the system may continue to monitor the person and keep determining their level of preoccupation in real time. If at step 908 it is determined that the level of preoccupation of the person exceeds the threshold, the system may determine the current environmental conditions at step 910. At step 912, the system may generate an alert based on the current environmental conditions and the level of preoccupation being greater than the threshold. Thereafter, at step 914, the system may output the alert in the direction of the person. In some embodiments, the system may perform further actions such as those described above with reference to steps 814-820 of FIG. 8.

In some embodiments, the interaction assessment system 242 may be enable or disabled by a user of the vehicle based on time and/or driving conditions. In other embodiments, the rate of monitoring of persons and/or outputting of the alert may be scaled up or down based on the environmental conditions, local rules, etc. In some embodiments, people can subscribe to an alert service (e.g., via an application on the mobile device). An entity may operate such an alert service using the server 104 and/or the vehicle 102. Anyone who has subscribed to such a service may receive an alert on their mobile device in any of the scenarios described above. If a person subscribed to such an alert service, they may set their preferences of receiving alerts in their profile information thus tailoring the alert service for a more customized user experience. A person may register their mobile device with the service operator and the service operator may use the mobile device information to send customized alerts to the person (e.g., the targeted BLE advertisement). In some embodiments, multiple types of alerts may be sent concurrently to the person of concern. For example, the system may output directional sound toward the person and send a BLE message to the mobile device of the person. This may increase the likelihood of the person receiving the alert.

FIG. 10 depicts a block diagram of an example control server 1000 (e.g., control server 104 of FIG. 1) upon which any of one or more techniques (e.g., methods) may be performed or which may perform the methods described above in conjunction with the vehicle 102, in accordance with one or more example embodiments of the present disclosure. In other embodiments, the server 1000 may operate as a standalone device or may be connected (e.g., networked) to other servers. In a networked deployment, the server 1000 may operate in the capacity of a server machine, a client machine, or both in server-client network environments. In an example, the server 1000 may act as a peer server in peer-to-peer (P2P) (or other distributed) network environments. The server 1000 may be a personal computer (PC), a tablet PC, a set-top box (STB), a personal digital assistant (PDA), a mobile telephone, a smart key fob, a wearable computer device, a web appliance, a network router, a switch or bridge, or any machine capable of executing instructions (sequential or otherwise) that specify actions to be taken by that server, such as a base station. Further, while only a single server is illustrated, the term “server” shall also be taken to include any collection of servers that individually or jointly execute a set (or multiple sets) of instructions to perform any one or more of the methodologies discussed herein, such as cloud computing, software as a service (Saas), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer-readable medium containing instructions where the instructions configure the execution units to carry out a specific task when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The server (e.g., computer system) 1000 may include a hardware processor 1002 (e.g., a central processing unit (CPU), a graphics processing unit (GPU), a hardware processor core, or any combination thereof), a main memory 1004 and a static memory 1006, some or all of which may communicate with each other via an interlink (e.g., bus) 1008. The server 1000 may further include a graphics display device 1010, an alphanumeric input device 1012 (e.g., a keyboard), and a user interface (UI) navigation device 1014 (e.g., a mouse). In an example, the graphics display device 1010, alphanumeric input device 1012, and UI navigation device 1014 may be a touch screen display. The server 1000 additionally may include a storage device (i.e., drive unit) 1016, a network interface device/transceiver 1020 coupled to antenna(s), and one or more sensors 1028, such as a global positioning system (GPS) sensor, a compass, an accelerometer, or another sensor. The server 1000 may include an output controller 1034, such as a serial (e.g., universal serial bus (USB)), parallel, or other wired or wireless (e.g., infrared (IR)), near field communication (NFC), etc. connection to communicate with or control one or more peripheral devices (e.g., a printer, a card reader, etc.).

The storage device 1016 may include a machine-readable medium 1022 on which is stored one or more sets of data structures or instructions (e.g., software) embodying or being utilized by any one or more of the techniques or functions described herein. The instructions also may reside, completely or at least partially, within the main memory 1004, within the static memory 1006, or within the hardware processor 1002 during execution thereof by the server 1000. In an example, one or any combination of the hardware processor 1002, the main memory 1004, the static memory 1006, or the storage device 1016 may constitute machine-readable media.

While the machine-readable medium 1022 is illustrated as a single medium, the term “machine-readable medium” may include a single medium or multiple media (e.g., a centralized or distributed database, and/or associated caches and servers) configured to store the one or more instructions.

Various embodiments may be implemented fully or partially in software and/or firmware. This software and/or firmware may take the form of instructions contained in or on a non-transitory computer-readable storage medium. Those instructions then may be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as, but not limited to, read-only memory (ROM) random access memory (RAM), magnetic disk storage media, optical storage media, a flash memory, etc.

The term “machine-readable medium” may include any medium that is capable of storing, encoding, or carrying instructions for execution by the server 1000 and that causes the server 1000 to perform any one or more of the techniques of the present disclosure, or that is capable of storing, encoding, or carrying data structures used by or associated with such instructions. Nonlimiting machine-readable medium examples may include solid-state memories and optical and magnetic media. In an example, a massed machine-readable medium includes a machine-readable medium with a plurality of particles having resting mass. Specific examples of massed machine-readable media may include nonvolatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions may further be transmitted or received over a communications network using a transmission medium via the network interface device/transceiver 1020 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1020 may include one or more physical jacks (e.g., Ethernet, coaxial, or phone jacks) or one or more antennas to connect to the communications network. In an example, the network interface device/transceiver 1020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the server 1000 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

It is to be noted that the vehicle implements and/or performs operations, as described here in the present disclosure, in accordance with the owner's manual and safety guidelines. In addition, any action taken by the vehicle owner/driver based on recommendations or notifications provided by the vehicle should comply with all the rules specific to the location and operation of the vehicle (e.g., federal, state, country, city, etc.). The recommendations or notifications, as provided by the vehicle, should be treated as suggestions and only followed according to any rules specific to the location and operation of the vehicle. In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more hardware, software, firmware, digital components, or analog components. For example, one or more application-specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name but not in function.

It should also be understood that the word “example,” as used herein, is intended to be non-exclusionary and nonlimiting in nature. More particularly, the word “example,” as used herein, indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, nonvolatile media and volatile media. Computing devices may include computer-executable instructions, where the instructions may be executable by one or more computing devices, such as those listed above, and stored on a computer-readable medium.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed to limit the claims.

Accordingly, it is to be understood that the above description is intended to be illustrative and not restrictive. Many embodiments and applications other than the examples provided would be apparent upon reading the above description. The scope should be determined not with reference to the above description but should instead be determined with reference to the appended claims, along with the full scope of equivalents to which such claims are entitled. It is anticipated and intended that future developments will occur in the technologies discussed herein and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A method comprising:
determining presence of a person in an environment around a vehicle;
determining, based on a trajectory of the person, that the person is likely to be present within an interaction zone of the vehicle;
determining that the person is currently preoccupied;
determining, by monitoring the person's behavior over time using data from one or more sensors of the vehicle, a level of preoccupation of the person;
determining that the level of preoccupation exceeds a threshold; and
outputting an alert in a direction toward the person, wherein outputting the alert comprises outputting directional audio using beamforming or a directed light beam toward the person.

2. The method of claim 1, further comprising:
determining current environmental data associated with the environment; and
generating the alert based on the current environmental data.

3. The method of claim 1, further comprising:
determining a behavior of the person after outputting the alert;
modifying the alert based on the behavior to generate a second alert; and
outputting the second alert in the direction toward the person.

4. The method of claim 1, wherein outputting the alert in the direction toward the person includes outputting directional audio using beamforming and a directed light beam toward the person.

5. The method of claim 1, further comprising:
determining, after outputting the alert, a change in the trajectory of the person; and
ceasing outputting of the alert.

6. The method of claim 1, wherein determining that the person is currently preoccupied further comprises one or more of:
determining, using one or more sensors of the vehicle, a current behavior of the person; or
determining physical attributes of the person and one or more objects carried by the person.

7. The method of claim 6, wherein the current behavior comprises one or more of:
the person interacting with a mobile device;
the person being in a conversation; or
the person looking in a direction opposite to the vehicle.

8. A method comprising:
determining an interaction zone associated with a vehicle;
determining that a person in a vicinity of the vehicle is likely to be present within the interaction zone in a near future;
determining that the person is currently preoccupied;
determining, by monitoring the person's behavior over time using data from one or more sensors of the vehicle, a level of preoccupation of the person;
determining environmental conditions in the vicinity of the vehicle;
generating an alert based on the environmental conditions and the person being preoccupied; and
outputting the alert in a direction toward the person, wherein outputting the alert comprises outputting directional audio using beamforming or a directed light beam toward the person.

9. The method of claim 8, further comprising:
determining that the level of preoccupation exceeds a threshold.

10. The method of claim 8, further comprising
monitoring, after outputting the alert, a behavior of the person;
modifying, based on the behavior, the alert to generate a modified alert; and
outputting the modified alert.

11. The method of claim 8, wherein the alert includes one or more of:
a directed audio signal;
a directed light output; or
a directed Bluetooth low energy advertisement message.

12. The method of claim 8, wherein outputting the alert further comprises one or more of:
outputting a directed audio signal in a direction toward the person;
outputting a directed light beam in the direction toward the person; or outputting Bluetooth low energy advertisement message receivable by a device of the person.

13. The method of claim 8, wherein determining that the person is preoccupied further comprises:
receiving data from one or more sensors of the vehicle; and
determining, based on the data, that the person is one of: interacting with a mobile device, in a conversation, or carrying an object indicative of a physical disability.

14. The method of claim 8, wherein the environmental conditions include one or more of:
ambient light;
ambient noise;
density of people within the vicinity; or
weather conditions.

15. A vehicle comprising:
one or more sensors;
an interaction prediction and analysis unit including a controller and coupled to the one or more sensors;
an alert generation and output unit coupled to the interaction prediction and analysis unit; and
a memory device coupled to the controller and storing instructions that, when executed by the controller, causes the controller to:
determine, using the one or more sensors, a presence of a person in an environment around the vehicle;
determine, based on a trajectory of the person, that the person is likely to be present within an interaction zone of the vehicle;
determine, by monitoring the person's behavior over time using data from the one or more sensors, a level of preoccupation of the person;
determine that the level of preoccupation exceeds a threshold; and
cause the alert generation and output unit to output an alert in a direction toward the person, wherein the alert comprises directional audio using beamforming or a directed light beam directed toward the person.

16. The vehicle of claim 15, wherein the instructions further cause the controller to:
determine current environmental data associated with the environment; and
cause the alert generation and output unit to generate the alert based on the current environmental data.

17. The vehicle of claim 15, wherein the instructions further cause the controller to:
determine a behavior of the person after outputting the alert;
cause the alert generation and output unit to generate a second alert based on the behavior to generate a modified alert; and
cause the alert generation and output unit to output the second alert in the direction toward the person.

18. The vehicle of claim 15, wherein to determine that the person is currently preoccupied, the instructions further cause the controller to:
receive data from the one or more sensors; and
determine, based on the data, that the person is one of: interacting with a mobile device, engrossed in a conversation, or carrying an object indicative of a physical disability.

19. The vehicle of claim 15, wherein the alert includes one or more of:
a directed audio signal;
a directed light output; or
a directed Bluetooth low energy advertisement message.

20. The vehicle of claim 15, wherein the instructions further cause the controller to:
determine a behavior of the person after outputting the alert; and
cease outputting the alert based on the behavior.
